(19) United States
(12) Patent Application Publication
(10) Pub. No.: US 2026/0153842 A1
(43) Pub. Date: Jun. 4, 2026

(54) CONTROL CIRCUIT, MICROCONTROLLER, AND CONTROL METHOD

(71) Applicant: Nuvoton Technology Corporation, Hsinchu Science Park (TW)

(72) Inventor: Chi-Feng WU, Hsinchu Science Park (TW)

(21) Appl. No.: 19/388,305

(22) Filed: Nov. 13, 2025

(30) Foreign Application Priority Data
Dec. 4, 2024 (TW) 113146879

(51) Int. Cl. G05B 13/02

(52) U.S. Cl. CPC G05B 13/0265

(57) ABSTRACT

A control circuit including a detection circuit, a sampling circuit, and an operational circuit is provided. The detection circuit collects first external information to generate a first detection signal. The sampling circuit has a first sampling rate and samples the first detection signal to generate a first sampled signal. The operational circuit inputs the first sampled signal to an inference model to generate an inference result, and determines whether the first predetermined condition is satisfied according to the inference result. In response to the first predetermined condition being satisfied, the operational circuit adjusts the first sampling rate from the first predetermined value to the second predetermined value. In response to the first predetermined condition not being satisfied, the operational circuit maintains the first sampling rate at the first predetermined value.

### CROSS REFERENCE TO RELATED APPLICATIONS

This application claims priority of Taiwan Patent Application No. 113146879, filed on Dec. 4, 2024, the entirety of which is incorporated by reference herein.

### TECHNICAL FIELD

The present disclosure relates to a control circuit, and, in particular, it relates to a control circuit for dynamically adjusting a sampling rate.

### BACKGROUND

The types and functions of electronic products are constantly increasing thanks to the ongoing advancements being made in the relevant technologies. Most electronic products comprise at least one sampling circuit, which samples an input signal at a particular sampling rate to generate a sampled signal. When the sampling rate is high, the sampled signal is more accurate, but this increases the power consumption of the sampling circuit. If the sampling rate is reduced to save power, the reliability of the sampled signal may be greatly reduced as well.

### BRIEF SUMMARY

An embodiment of the present disclosure provides a control circuit comprising a detection circuit, a sampling circuit, and an operational circuit. The detection circuit collects first external information to generate a first detection signal. The sampling circuit has a first sampling rate and samples the first detection signal to generate a first sampled signal. The operational circuit inputs the first sampled signal to an inference model to generate an inference result, and determines whether a first predetermined condition is satisfied according to the inference result. In response to the first predetermined condition being satisfied, the operational circuit adjusts the first sampling rate from a first predetermined value to a second predetermined value. In response to the first predetermined condition not being satisfied, the operational circuit maintains the first sampling rate at the first predetermined value.

An embodiment of the present disclosure provides a microcontroller which comprises a detection circuit, a sampling circuit, an operational circuit, and a processing circuit. The detection circuit collects external information to generate a detection signal. The sampling circuit has a sampling rate and samples the detection signal to generate a sampled signal. The operational circuit inputs the sampled signal to an inference model to generate an inference result and determines whether a first predetermined condition is satisfied according to the inference result. The processing circuit performs a predetermined operation according to the sampled signal. In response to the first predetermined condition not being satisfied, the operational circuit inputs a first parameter group to the inference model. In response to the first predetermined condition being satisfied, the operational circuit inputs a second parameter group to the inference model and adjusts the sampling rate.

A control method is provided. An exemplary embodiment of a control method is described in the following paragraph. A sampling rate is set at a first predetermined value. A detection signal is sampled to generate a sampled signal. The sampled signal and a first parameter group are provided to an inference model to generate an inference result. It is determined whether the sampling rate needs to be changed according to the inference result. In response to the sampling rate not needing to be changed, the first parameter group is provided to the inference model. In response to the sampling rate needing to be changed, the sampling rate is set at a second predetermined value and the sampled signal and a second parameter group are provided to the inference model. It is determined whether the sampling rate needs to be changed again. In response to the sampling rate needing to be changed again, the sampling rate is set at the first predetermined value and the first parameter group is provided to the inference model. In response to the sampling rate not needing to be changed again, the second parameter group is provided to the inference model.

Control method may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a control circuit and a microcontroller for practicing the disclosed method.

### BRIEF DESCRIPTION OF THE DRAWINGS

The present disclosure can be more fully understood by reading the subsequent detailed description and examples with references made to the accompanying drawings, wherein:

FIG. 1 is a schematic diagram of an exemplary embodiment of a microcontroller according to various aspects of the present disclosure;

FIG. 2 is a schematic diagram of an exemplary embodiment of a control circuit according to various aspects of the present disclosure;

FIG. 3 is a schematic diagram of another exemplary embodiment of the control circuit according to various aspects of the present disclosure;

FIG. 4 is a schematic diagram of another exemplary embodiment of the control circuit according to various aspects of the present disclosure;

FIG. 5 is a schematic diagram of another exemplary embodiment of the control circuit according to various aspects of the present disclosure; and

FIG. 6 is a flowchart of an exemplary embodiment of a control method according to various aspects of the present disclosure.

### DETAILED DESCRIPTION

The present disclosure will be described with respect to particular embodiments and with reference to certain drawings, but the disclosure is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the present disclosure.

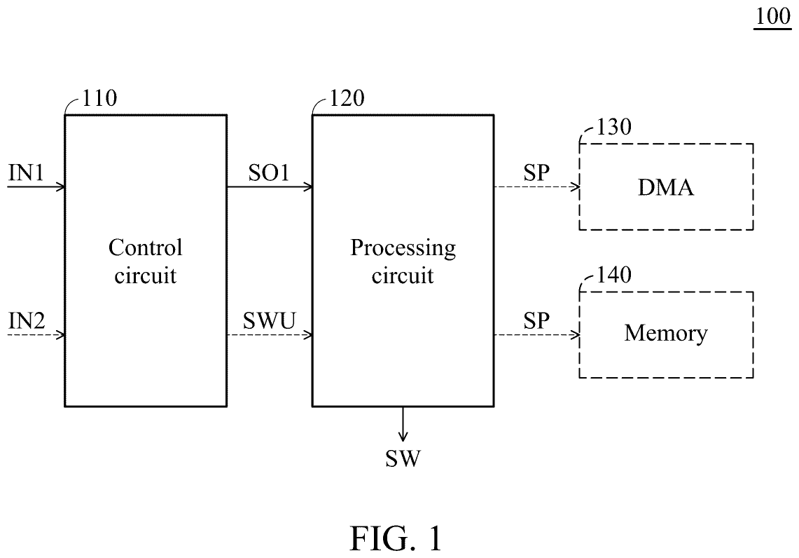

FIG. 1 is a schematic diagram of an exemplary embodiment of a microcontroller according to various aspects of the present disclosure. The microcontroller 100 comprises a control circuit 110 and a processing circuit 120. The control circuit 110 detects external information IN1 to generate an output signal SO1. In one embodiment, the control circuit 110 comprises a sensor (not shown) to detect the external information IN1. In this case, the control circuit 110 samples the external information IN1 to generate a sampling result and serves the sampling result as the output signal SO1.

In this embodiment, the control circuit 110 determines whether a predetermined condition is satisfied according to the external information IN1. When the predetermined condition does not be satisfied, the control circuit 110 does not adjust a sampling rate. When the predetermined condition is satisfied, the control circuit 110 adjusts the sampling rate. In some embodiment, when the predetermined condition is satisfied, the control circuit 110 may enable a wakeup signal SWU. In one embodiment, the microcontroller 100 may be applied to a wearable medical device, a remote medical device, or a precision medical device.

In other embodiments, the control circuit 110 further detects external information IN2. In this case, the control circuit 110 determines whether a predetermined condition is satisfied according to the external information IN1. When the predetermined condition is satisfied, the control circuit 110 adjusts a sampling rate and samples the external information IN2 according to the adjusted sampling rate. The control circuit 110 serves the sampling result as the output signal SO1.

The types of external information IN1 and IN2 are not limited in the present disclosure. The external information IN1 or IN2 may be continuous information or discrete information. In some embodiments, at least one of the external information IN1 and IN2 may be a physical characteristic, a physiological characteristic, an electrical characteristic, or an environmental characteristic. Taking the external information IN1 as an example, the external information IN1 may be temperature information, pressure information, flow information, displacement information, acceleration information, current information, humidity information, chemical concentration information, audio information, electrocardiogram information, or blood oxygen concentration information. In one embodiment, the type of external information IN1 is different from the type of external information IN2. For example, the external information IN1 may be blood pressure information, and the external information IN2 may be blood oxygen information.

The processing circuit 120 performs a predetermined operation according to the output signal SO1. In one embodiment, the processing circuit 120 determines whether an abnormal event occurs according to the output signal SO1. When an abnormal event occurs, the processing circuit 120 issues a warning message SW. The warning message SW may be a warning sound or a warning image. In other embodiments, the processing circuit 120 processes the output signal SO1 to generate a processing signal SP. The processing circuit 120 may provide the processing signal SP to a direct memory access circuit (DMA) 130. The processing circuit 120 requests the direct memory access circuit 130 to store the processing signal SP in a corresponding memory. In another embodiment, the processing circuit 120 stores the processing signal SP in a memory 140. In some embodiments, the processing circuit 120 directly uses the output signal SO1 as the processing signal SP.

In other embodiments, when the processing circuit 120 is idle, the processing circuit 120 may enter a sleep mode. In the sleep mode, the processing circuit 120 is temporarily inactive, such as stopping perform a predetermined operation. In this case, when the wakeup signal SWU is enabled, the processing circuit 120 exits the sleep mode and enters a normal mode. In the normal mode, the processing circuit 120 performs a predetermined operation according to the output signal SO1.

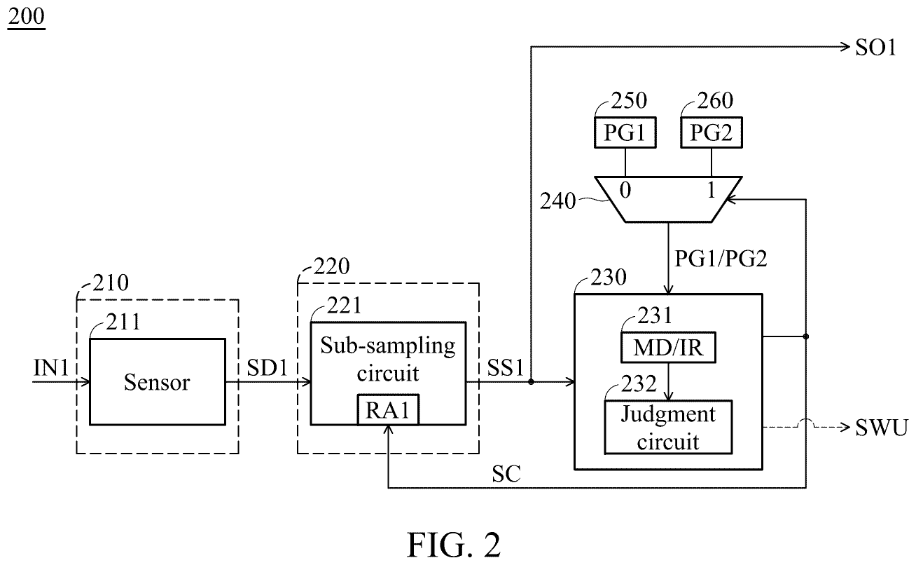

FIG. 2 is a schematic diagram of an exemplary embodiment of a control circuit according to various aspects of the present disclosure. The control circuit 200 comprises a detection circuit 210, a sampling circuit 220 and an operational circuit 230. The detection circuit 210 collects the external information IN1 to generate a detection signal SD1. The structure of the detection circuit 210 comprises a sensor 211. The sensor 211 detects the external information IN1 to generate the detection signal SD1. The kind of sensor 211 is not limited in the present disclosure. The sensor 211 may be a temperature sensor, a pressure sensor, a flow sensor, a displacement sensor, an acceleration sensor, a current sensor, a humidity sensor, a chemical concentration sensor, an audio sensor, an electrocardiogram sensor, a blood oxygen concentration sensor, a gyroscope sensor, or a resistive sensor.

The sampling circuit 220 has a sampling rate RA1 and samples the detection signal SD1 to generate a sampled signal SS1. In this embodiment, the sampling circuit 220 comprises a sub-sampling circuit 221. The sub-sampling circuit 221 samples the detection signal SD1 according to the sampling rate RA1 to generate the sampled signal SS1. In one embodiment, the sampled signal SS1 is served as the output signal SO1.

In this embodiment, the sub-sampling circuit 221 performs a corresponding number of sampling operations on the detection signal SD1 according to the sampling rate RA1. For example, when the sampling rate RA1 matches the first predetermined value, the number of sampling operations performed by the sub-sampling circuit 221 during a predetermined period is a first value (e.g., 100). When the sampling rate RA1 matches the second predetermined value, the number of sampling operations performed by the sub-sampling circuit 221 during the same predetermined period is a second value (e.g., 1000). In this case, the second value may be higher than the first value, but the disclosure does not limited thereto. In other embodiments, the second value is lower than the first value.

The operational circuit 230 inputs the sampled signal SS1 to an inference model MD to generate an inference result IR. The operational circuit 230 determines whether a predetermined condition is satisfied according to the inference result IR. When the predetermined condition is satisfied, the operational circuit 230 generate a control signal SC to adjust (increase or reduce) the sampling rate RA1 from the first predetermined value to the second predetermined value. When the predetermined condition is not satisfied, the operational circuit 230 uses the control signal SC to maintain the sampling rate RA1 at the first predetermined value. In some embodiment, when the predetermined condition is satisfied, the operational circuit 230 enables a wakeup signal SWU.

For example, when a sudden change occurs at the external information IN1, it indicates that a predetermined condition is satisfied. Therefore, the operational circuit 230 generates a control signal SC to adjust the sampling rate RA1 from the first predetermined value (e.g., 1 Hz) to the second predetermined value (e.g., 100 Hz). When the external information IN1 is in a stable range, it indicates that the predetermined condition is not satisfied, the operational circuit 230 maintains the sampling rate RA1 at the first predetermined value (e.g., 1 Hz) or adjusts the sampling rate RA1 from the second predetermined value (e.g., 100 Hz) to the first predetermined value (e.g., 1 Hz) via the control signal SC.

In other embodiments, when the external information IN1 is within a stable range, it indicates that a predetermined condition has been met. Therefore, the operational circuit 230 generates a control signal SC to reduce the sampling rate RA1 from the first predetermined value (e.g., 44 KHz) to the second predetermined value (e.g., 1 KHz). In this case, when the external information IN1 is not within a stable range, it indicates that the predetermined condition has not been met. Therefore, the operational circuit 230 increases the sampling rate RA1 via the control signal SC, for example, from the second predetermined value (e.g., 1 KHz) to the first predetermined value (e.g., 44 KHz).

In some embodiments, the operational circuit 230 inputs a corresponding parameter group into the inference model MD according to the sampling rate RA1. For example, when the sampling rate RA1 is equal to the first predetermined value, the operational circuit 230 inputs the sampled signal SS1 and a parameter group PG1 (also referred to as the first parameter group) into the inference model MD. When the sampling rate RA1 is equal to the second predetermined value, the operational circuit 230 inputs the sampled signal SS1 and a parameter group PG2 (also referred to as the second parameter group) into the inference model MD. In some embodiments, each of the parameter groups PG1 and PG2 comprises many parameters.

The structure of operational circuit 230 is not limited in the present disclosure. In one embodiment, the operational circuit 230 comprises a storage circuit 231 and a judgment circuit 232. The storage circuit 231 stores the inference model MD. The type of the inference model MD is not limited in the present disclosure. In one embodiment, the inference model MD is a recurrent neural network (RNN) model, such as a long short-term memory (LSTM) or a gated recurrent unit (GRU).

The judgment circuit 232 reads the storage circuit 231 to execute the inference model MD. During an initial period, the judgment circuit 232 inputs the parameter group PG1 and the sampled signal SS1 to the inference model MD to obtain an inference result IR. The judgment circuit 232 may store the inference result IR in the storage circuit 231, or store the inference result IR in another independent storage circuit (different from the storage circuit 231). The judgment circuit 232 determines whether a predetermined condition is satisfied according to the inference result IR, and generates a control signal SC according to the determined result to adjust the sampling rate RA1. In one embodiment, the judgment circuit 232 enables the wakeup signal SWU according to on the determined result.

In other embodiments, the control circuit 200 further comprises a multiplexer 240. The multiplexer 240 receives the parameter groups PG1 and PG2. In this case, the multiplexer 240 provides the parameter group PG1 or PG2 to the operational circuit 230 according to the control signal SC. When the operational circuit 230 sets the sampling rate RA1 at the first predetermined value via the control signal SC, the multiplexer 240 provides the parameter group PG1 to the operational circuit 230 according to the control signal SC. When the operational circuit 230 sets the sampling rate RA1 at the second predetermined value via the control signal SC, the multiplexer 240 provides the parameter group PG2 to the operational circuit 230 according to the control signal SC.

In some embodiments, the control circuit 200 further comprises storage circuits 250 and 260. The storage circuit 250 is configured to store the parameter group PG1. The storage circuit 260 is configured to store parameter group PG2. In one embodiment, the storage circuits 250 and 260 are two independent memories. In another embodiment, the storage circuits 250 and 260 are integrated into a memory. In this case, the parameter groups PG1 and PG2 are stored in different memory blocks.

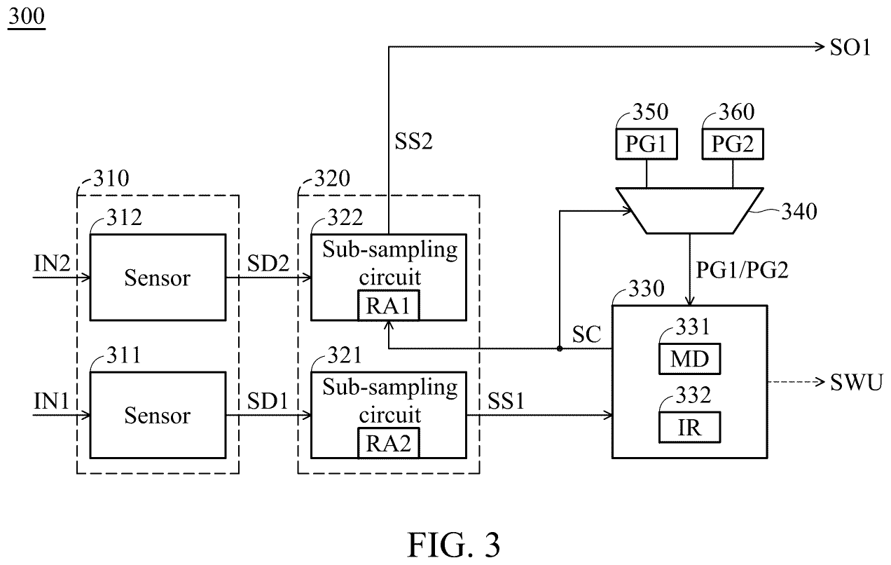

FIG. 3 is a schematic diagram of another exemplary embodiment of the control circuit according to various aspects of the present disclosure. The control circuit 300 comprises a detection circuit 310, a sampling circuit 320, and an operational circuit 330. The detection circuit 310 detects the external information IN1 to generate the detection signal SD1 and detects the external information IN2 to generate a detection signal SD2. The type of external information IN2 may be the same as or different from the type of the external information IN1. Since the feature of external information IN2 is the same as the feature of external information IN1, the feature of external information IN2 is omitted.

In this embodiment, the detection circuit 310 comprises sensors 311 and 312. The sensor 311 collects the external information IN1 to generate the detection signal SD1. The sensor 312 collects the external information IN2 to generate the detection signal SD2. Since the characteristics of the sensors 311 and 312 are similar to the characteristics of the sensor 211 shown in FIG. 2, the related description is omitted here.

In some embodiments, the external information IN1 is a first physiological characteristic, and the external information IN2 is a second physiological characteristic. In this case, the first physiological characteristic is different from the second physiological characteristic. For example, the sensor 311 is a blood oxygen concentration sensor, and sensor 312 is an electrocardiogram sensor. In this case, control circuit 300 may be used in medical monitoring.

In another embodiment, the sensor 311 is a resistive sensor for measuring changes in resistance on the skin surface. The sensor 312 may be an acceleration sensor, a blood oxygen sensor, or an electrocardiogram sensor. In this case, the control circuit 300 is used to monitor the physiological and emotional state of the human body. In some embodiments, the sensor 311 is a temperature sensor or a pressure sensor, and the sensor 312 is a flow sensor. In this case, the control circuit 300 is used in an industrial automation system. In another embodiment, the sensor 311 is a gyroscope sensor, and the sensor 312 is an acceleration sensor. In this case, the control circuit 300 is used to track the movement of an object.

The sampling circuit 320 samples the detection signal SD1 according to a sampling rate RA2 to generate a sampled signal SS1. The sampling circuit 320 samples the detection signal SD2 according to the sampling rate RA1 to generate a sampled signal SS2. In one embodiment, the sampled signal SS2 serves as the output signal SO1. In this embodiment, the sampling rate RA2 is fixed, but the disclosure if not limited. In other embodiments, both the sampling rates RA1 and RA2 are adjustable.

The structure of sampling circuit 320 is not limited in the present disclosure. In one embodiment, the sampling circuit 320 comprises sub-sampling circuits 321 and 322. The sub-sampling circuit 321 samples the detection signal SD1 according to the sampling rate RA2 to generate the sampled signal SS1. The sub-sampling circuit 322 samples the detection signal SD2 according to the sampling rate RA1 to generate the sampled signal SS2.

The operational circuit 330 inputs the sampled signal SS1 and the parameter group PG1 to the inference model MD to generate an inference result IR. The operational circuit 330 determines whether a predetermined condition is satisfied according to the inference result IR. When the predetermined condition is not satisfied, the operational circuit 330 maintains the sampling rate RA1 at the first predetermined value and uses the parameter group PG1. When the predetermined condition is satisfied, the operational circuit 330 adjusts the sampling rate RA1 at the second predetermined value via the control signal SC and uses the parameter group PG2. In this embodiment, regardless of whether the predetermined condition is satisfied, the sampling rate RA2 is fixed. In some embodiments, the inference model MD may be stored in the memory 331. The inference result IR may be stored in the memory 332.

Assume that the sensors 311 and 312 are sound sensors. The sub-sampling circuit 321 samples the detection signal SD1 according to the sampling rate RA2 to analyze the characteristics of the audio signal. At this time, the sub-sampling circuit 321 may sample the detection signal SD1 at a low sampling rate (such as 1 KHz). When the operational circuit 330 determines that the external information IN1 has changed significantly according to the sampled signal SS1, the operational circuit 330 adjusts the sampling rate RA1 and directs the sub-sampling circuit 322 to increase the number of sampling times. At this time, the sampling rate RA1 of the sub-sampling circuit 322 may increase from an initial frequency to a predetermined frequency (for example, 44.1 KHz or higher) to capture the details of the audio signal.

In other embodiments, the sensors 311 and 312 are different types of sensors. For example, assume that the sensor 311 is a blood oxygen concentration sensor and the sensor 312 is an electrocardiogram sensor. In this case, the sub-sampling circuit 321 samples detection signal SD1 at a fixed sampling speed (e.g., 1 Hz) according to sampling rate RA2. When operational circuit 330 detects a significant change in the external information IN1 according to sampled signal SS1, the operational circuit 330 adjusts sampling rate RA1 and directs the sub-sampling circuit 322 to perform sampling at a predetermined sampling rate. In this case, the sub-sampling circuit 322 may sample the detection signal SD2 at a high sampling rate (e.g., 200 Hz or higher). Because the operational circuit 330 increases the sampling rate of the sub-sampling circuit 322, the accuracy and reliability of the output signal SO1 can be increased. However, when the operational circuit 330 determines that the external information IN1 is maintained in a stable range according to the sampled signal SS1, the operational circuit 330 maintains the sampling rate RA1 at an initial rate. Since the operational circuit 330 dynamically controls the sampling rate of the sub-sampling circuit 322, the power consumption of the sub-sampling circuit 322 can be reduced.

In other embodiments, the control circuit 300 further comprises a multiplexer 340 and storage circuits 350 and 360. Since the characteristics of the multiplexer 340, storage circuits 350 and 360 are similar to the characteristics of the multiplexer 240, storage circuits 250 and 260 shown in FIG. 2, the related description is omitted here.

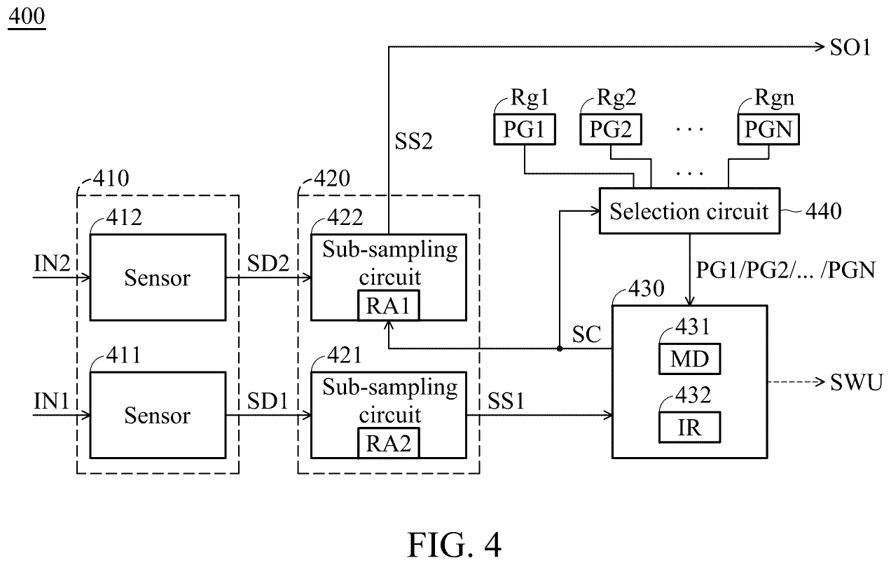

FIG. 4 is a schematic diagram of another exemplary embodiment of the control circuit according to various aspects of the present disclosure. The control circuit 400 comprises a detection circuit 410, a sampling circuit 420, an operational circuit 430, a selection circuit 440 and storage circuits Rg1˜RgN. Since the characteristics of the detection circuit 410, the sampling circuit 420, and the operational circuit 430 are similar to the characteristics of the detection circuit 310, the sampling circuit 320, and the operational circuit 330 shown in FIG. 3, the related description is omitted here.

The selection circuit 440 outputs one of the parameter groups PG1˜PGN to the operational circuit 430 according to the control signal SC. In one embodiment, the parameter groups PG1˜PGN are respectively stored in storage circuits Rg1˜RgN. In this case, the storage circuits Rg1˜RgN may be different memories. In another embodiment, the parameter groups PG1˜PGN are stored in the same memory.

When a first predetermined condition is not satisfied, the operational circuit 430 maintains the sampling rate RA1 at a first predetermined value via the control signal SC and directs the selection circuit 440 to provide the parameter group PG1. When the first predetermined condition is satisfied (for example, the detection signal SD1 has a first slope), the operational circuit 430 sets the sampling rate RA1 at a second predetermined value via the control signal SC and directs the selection circuit 440 to provide the parameter group PG2.

In other embodiments, when the sampling rate RA1 matches the second predetermined value, the operational circuit 430 determines whether the second predetermined condition is satisfied according to the inference result IR. When the second predetermined condition is not satisfied, the operational circuit 430 maintains the sampling rate RA1 at the second predetermined value. When the second predetermined condition is satisfied (e.g., the detection signal SD1 has a second slope), the operational circuit 430 sets the sampling rate RA1 at a third predetermined value via the control signal SC, and directs the selection circuit 440 to provide the parameter group PG3 (not shown). In this embodiment, regardless of whether the first and second predetermined conditions are satisfied, the sampling rate RA2 is fixed. In some embodiments, the third predetermined value is greater than the second predetermined value, and the second predetermined value is greater than the first predetermined value.

In other embodiments, different predetermined conditions correspond to different sampling rates RA1 and different parameter groups. For example, when the first predetermined condition is satisfied, the operational circuit 430 sets the sampling rate RA1 at the first predetermined value and directs the selection circuit 440 to provide the parameter group PG1. When the second predetermined condition is satisfied, the operational circuit 430 sets the sampling rate RA1 at the second predetermined value and directs the selection circuit 440 to provide the parameter group PG2. When the third predetermined condition is satisfied, the operational circuit 430 sets the sampling rate RA1 at a third predetermined value and directs the selection circuit 440 to provide the parameter group PG3.

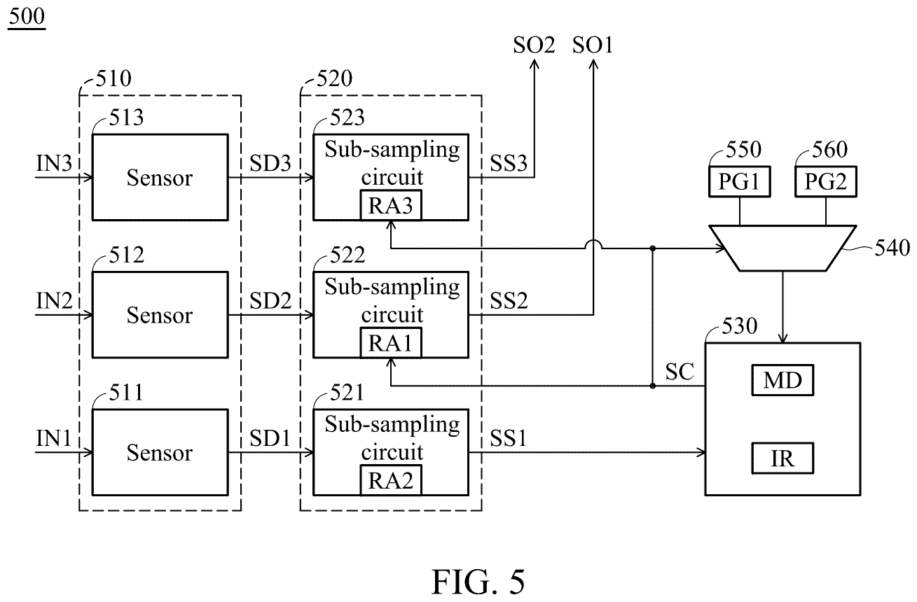

FIG. 5 is a schematic diagram of another exemplary embodiment of the control circuit according to various aspects of the present disclosure. The control circuit 500 comprises a detection circuit 510, a sampling circuit 520, an operational circuit 530, a multiplexer 540, and storage circuits 550 and 560. Since the characteristics of the operational circuit 530, the multiplexer 540, and the storage circuits 550 and 560 are similar to the characteristics of the operational circuit 330, a multiplexer 340, and storage circuits 350 and 360 shown in FIG. 3, the related description is omitted here.

The detection circuit 510 comprises sensors 511˜513. Since the characteristics of the sensors 511 and 512 are similar to the characteristics of the sensors 311 and 312 shown in FIG. 3, the related description is omitted here. In this embodiment, the sensor 513 collects external information IN3 to generate a detection signal SD3. The type of sensor 513 is not limited in the present disclosure. The type of sensor 513 may be the same as that of sensor 511 or 512, or different from that of sensors 511 and 512. Since the characteristics of the external information IN3 are similar to the characteristics of the external information IN1, the related description is omitted here.

The sampling circuit 520 comprises sub-sampling circuits 521˜523. Since the characteristics of the sampling circuits 521 and 522 are similar to those of the sampling circuits 321 and 322 shown in FIG. 3, the related description is omitted here. In this embodiment, the sub-sampling circuit 523 samples the detection signal SD3 according to the sampling rate RA3 to generate a sampled signal SS3. In some embodiments, the sampled signal SS3 is served as an output signal 502. In this case, the output signal SO2 may be provided to the processing circuit 120 shown in FIG. 1.

The operational circuit 530 inputs the sampled signal SS1 to the inference model MD to generate an inference result IR, and determines whether the first predetermined condition is satisfied according to the inference result IR. When the first predetermined condition is not satisfied, the operational circuit 530 maintains the sampling rates RA1 and RA3 at the first predetermined value via the control signal SC, and directs the multiplexer 540 to provide the parameter group PG1. When the first predetermined condition is satisfied, the operational circuit 530 sets the sampling rates RA1 and RA3 at the second predetermined value via the control signal SC, and directs the multiplexer 540 to provide the parameter group PG2. In this example, the sampling rate RA1 is the same as the sampling rate RA3.

In other embodiments, the selection circuit 440 and the parameter groups PG1˜PGN of FIG. 4 may replace with the multiplexer 540 and the parameter groups PG1 and PG2 of FIG. 5. In this case, when different predetermined conditions are satisfied, the sampling rates RA1 and RA3 have different values, and the sampling rate RA2 is fixed.

In some embodiments, when the sampling rates RA1 and RA3 are at the first predetermined value, the sampling circuits 522 and 523 stop operating. When the first predetermined condition is satisfied, the sampling rates RA1 and RA3 may be at the second predetermined value. The sampling circuits 522 and 523 sample the detection signals SD2 and SD3 according to the sampling rates RA1 and RA3, respectively.

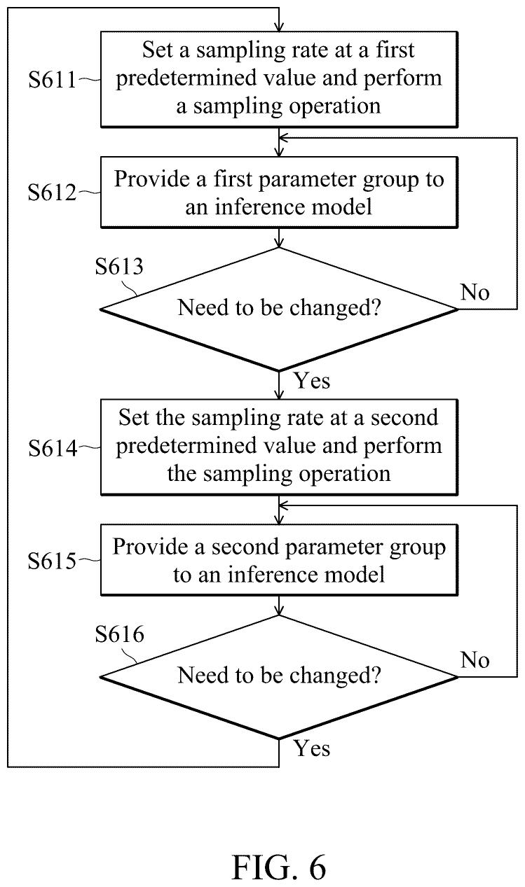

FIG. 6 is a flowchart of an exemplary embodiment of a control method according to various aspects of the present disclosure. Control methods may take the form of a program. When the program code is loaded into and executed by a machine, the machine thereby becomes a control circuit and a microcontroller for practicing the methods. First, a sampling rate is set at a first predetermined value, and a detection signal is sampled to generate a sampled signal (step S611). In one embodiment, the detection signal may be a continuous signal or a discrete signal. In other embodiments, step S611 is performed to drive a sensor to detect external information to provide a detection signal. The type of external information is not limited in the present disclosure. The external information can be any type of signal, such as a pulse-blood-oxygen saturation signal, an electrocardiogram signal, or an electroencephalogram signal.

The sampled signal and a first parameter group are provided to an inference model to generate an inference result (step S612). The first parameter group comprises a plurality of parameters. In one embodiment, the inference model is an RNN model, such as LSTM or GRU.

A determination is made as to whether the sampling rate needs to be changed according to the inference result (step S613). In one embodiment, step S613 is performed to determine whether a predetermined condition is satisfied according to the inference result. When the predetermined condition is not satisfied, it indicates that the sampling rate does not need to be changed. Therefore, step S612 is performed to provide the first parameter group to the inference model. However, when the predetermined condition is satisfied, it indicates that the sampling rate needs to be changed. Therefore, the sampling rate is set at the second predetermined value, and the detection signal is sampled (step S614).

The sampled signal and a second parameter group are provided to the inference model (step S615). Then, a determination is made as to whether the sampling rate needs to be changed again (step S616). In one embodiment, step S616 is performed to determine whether the sampling rate needs to be adjusted again according to the inference result. When the sampling rate needs to be adjusted again, step S611 is performed to set the sampling rate at the first predetermined value, and provide the first parameter group to the inference model (step S612). However, when the sampling rate does not need to be adjusted again, step S615 is performed to provide the second parameter group to the inference model.

In some embodiments, both step S613 and step S616 determine whether a predetermined condition is satisfied. For step S613, when the predetermined condition is satisfied, it indicates that the sampling rate needs to be adjusted. Therefore, the sampling rate is adjusted at the second predetermined value, and the second parameter group is provided to the inference model. In this case, for step S616, when the predetermined condition is satisfied, it indicates that the sampling rate does not need to be modified. Therefore, the sampling rate is maintained at the second predetermined value, and the second parameter group is provided to the inference model. However, in step S616, when the predetermined condition is not satisfied, it indicates that the sampling rate needs to be adjusted again. Therefore, the sampling rate is adjusted at the first predetermined value, and the first parameter group is provided to the inference model.

Control methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a control circuit and a microcontroller for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a control circuit and a microcontroller for practicing the disclosed methods. When implemented on a general-purpose processor, the program code combines with the processor to provide a unique apparatus that operates analogously to application-specific logic circuits.

While the disclosure has been described by way of example and in terms of the preferred embodiments, it should be understood that the disclosure is not limited to the disclosed embodiments. On the contrary, it is intended to cover various modifications and similar arrangements. For example, the systems, devices, or methods described in the embodiments of the present disclosure may be implemented as physical embodiments of hardware, software, or a combination of hardware and software. Therefore, the scope of the appended claims should be accorded the broadest interpretation so as to encompass all such modifications and similar arrangements.

What is claimed is:

1. A control circuit comprising:
a detection circuit collecting first external information to generate a first detection signal;
a sampling circuit having a first sampling rate and sampling the first detection signal to generate a first sampled signal; and
an operational circuit inputting the first sampled signal to an inference model to generate an inference result, and determining whether a first predetermined condition is satisfied according to the inference result,
wherein:
in response to the first predetermined condition being satisfied, the operational circuit adjusts the first sampling rate from a first predetermined value to a second predetermined value,
in response to the first predetermined condition not being satisfied, the operational circuit maintains the first sampling rate at the first predetermined value.

2. The control circuit as claimed in claim 1, wherein:
in response to the first sampling rate matching the first predetermined value, the operational circuit inputs a first parameter group to the inference model, and
in response to the first sampling rate matching the second predetermined value, the operational circuit inputs a second parameter group to the inference model.

3. The control circuit as claimed in claim 2, wherein the sampling circuit samples the first detection signal according to the first sampling rate to generate the first sampled signal.

4. The control circuit as claimed in claim 3, further comprising:
a multiplexer receiving the first and second parameter groups,
wherein:
in response to the first predetermined condition being satisfied, the operational circuit generates a control signal to the sampling circuit to adjust the first sampling rate,
the multiplexer provides the first or second parameter group to the operational circuit according to the control signal.

5. The control circuit as claimed in claim 4, wherein in response to the first sampling rate matching the second predetermined value and a second predetermined condition being satisfied, the operational circuit uses the control signal to direct the multiplexer to provide the first parameter group and adjusts the first sampling rate from the second predetermined value to the first predetermined value.

6. The control circuit as claimed in claim 2, wherein:
the sampling circuit samples the first detection signal according to a second sampling rate and sampling a second detection signal according to the first sampling rate,
the first sampling rate is controlled by the operational circuit, and
the second sampling rate is fixed.

7. The control circuit as claimed in claim 6, wherein:
the detection circuit comprises a first sensor and a second sensor, and the sampling circuit comprises a first sub-sampling circuit and a second sub-sampling circuit,
the first sensor collects the first external information to generate the first detection signal, and the second sensor collects second external information to generate the second detection signal,
the first sub-sampling circuit samples the first detection signal according to the second sampling rate, and the second sub-sampling circuit samples the second detection signal according to the first sampling rate.

8. The control circuit as claimed in claim 7, wherein the first external information is a first physiological characteristic, the second external information is a second physiological characteristic, and the first physiological characteristic is different from the second physiological characteristic.

9. The control circuit as claimed in claim 8, wherein in response to the operational circuit determining that the first predetermined condition is satisfied according to the inference result, the operational circuit adjusts the first sampling rate from the second predetermined value to a third predetermined value and inputs a third parameter group to the inference model.

10. The control circuit as claimed in claim 9, further comprising:
a selection circuit outputting the first, second or third parameter group to the operational circuit,
wherein the operational circuit generates a control signal to direct the selection circuit to provide the first, second or third parameter group.

11. The control circuit as claimed in claim 10, wherein:
the detection circuit further comprises a third sensor, and the sampling circuit further comprises a third sub-sampling circuit,
the third sensor collects third external information to generate a third detection signal,
the third sub-sampling circuit samples the third detection signal according to a third sampling rate, and
the operational circuit uses the control signal to adjust the third sampling rate.

12. The control circuit as claimed in claim 11, wherein the third sampling rate is the same as the first sampling rate.

13. A microcontroller, comprising:
a detection circuit collecting external information to generate a detection signal;
a sampling circuit having a sampling rate and sampling the detection signal to generate a sampled signal;
an operational circuit inputting the sampled signal to an inference model to generate an inference result and determining whether a first predetermined condition is satisfied according to the inference result; and
a processing circuit performing a predetermined operation according to the sampled signal,
wherein:
in response to the first predetermined condition not being satisfied, the operational circuit inputs a first parameter group to the inference model, and
in response to the first predetermined condition being satisfied, the operational circuit inputs a second parameter group to the inference model and adjusts the sampling rate.

14. The microcontroller as claimed in claim 13, wherein:
in response to the first predetermined condition being satisfied, the operational circuit adjusts the sampling rate from a first predetermined value to a second predetermined value,
in response to the sampling rate matching the second predetermined value and a second predetermined condition being satisfied, the operational circuit adjusts the sampling rate from the second predetermined value to the first predetermined value, and
the second predetermined value is higher than the first predetermined value.

15. The microcontroller as claimed in claim 14, further comprising:
a multiplexer receiving the first and second parameter groups and providing the first or second parameter groups to the operational circuit according to a control signal,
wherein the operational circuit generates the control signal according to the inference result to control the multiplexer and adjust the sampling rate.

16. The microcontroller as claimed in claim 13, wherein:
in response to the first predetermined condition being satisfied, the operational circuit adjusts the sampling rate from a first predetermined value to a second predetermined value, and
in response to the sampling rate matching the first predetermined value and a second predetermined condition being satisfied, the operational circuit adjusts the sampling rate from the second predetermined value to a third predetermined value, wherein
the third predetermined value is higher than the second predetermined value, and the second predetermined value is higher than the first predetermined value.

17. The microcontroller as claimed in claim 16, further comprising:
a selection circuit receiving the first parameter group, the second parameter group, and a third parameter group and providing the first, second or third parameter group to the operational circuit according to a control signal,
wherein the operational circuit generates the control signal according to the inference result to control the selection circuit and adjust the sampling rate.

18. The microcontroller as claimed in claim 13, wherein the predetermined operation is performed to determine whether an abnormal event occurs, and in response to the abnormal event occurring, the processing circuit issues a warning message.

19. The microcontroller as claimed in claim 18, wherein:
in response to the processing circuit entering a sleep mode, the processing circuit stops performing the predetermined operation,
in response to the processing circuit operating in the sleep mode and a wakeup signal being enabled, the processing circuit exits the sleep mode and performs the predetermined operation, and
in response to the first predetermined condition being satisfied, the operational circuit enables the wakeup signal.

20. A control method, comprising:
setting a sampling rate at a first predetermined value;
sampling a detection signal to generate a sampled signal;
providing the sampled signal and a first parameter group to an inference model to generate an inference result;
determining whether the sampling rate needs to be changed according to the inference result;
in response to the sampling rate not needing to be changed:
providing the first parameter group to the inference model,
in response to the sampling rate needing to be changed:
setting the sampling rate at a second predetermined value;
providing the sampled signal and a second parameter group to the inference model,
determining whether the sampling rate needs to be changed again,
in response to the sampling rate needing to be changed again:
setting the sampling rate at the first predetermined value; and
providing the first parameter group to the inference model, and
in response to the sampling rate not needing to be changed again:
providing the second parameter group to the inference model.
